(19) United States
(12) Patent Application Publication
(10) Pub. No.: US 2024/0230891 A1
(43) Pub. Date: Jul. 11, 2024

(54) QUAD POLARIZED ELECTRONICALLY STEERED WEATHER RADAR

(71) Applicant: Garmin International, Inc., Olathe, KS (US)

(72) Inventors: Adam G. Lohoefener, Olathe, KS (US); Taylor J. Whipple, Olathe, KS (US)

(21) Appl. No.: 18/404,988

(22) Filed: Jan. 5, 2024

Related U.S. Application Data
(60) Provisional application No. 63/479,121, filed on Jan. 9, 2023.

(51) Int. Cl. G01S 13/95; G01S 7/02; G01S 7/40; G01S 13/02

(52) U.S. Cl. CPC G01S 13/95; G01S 7/024; G01S 7/4034; G01S 2013/0254

(57) ABSTRACT

A system comprises an antenna array and a system controller and signal processor. The antenna array is formed from a plurality of antenna modules, each configured to operate in a horizontal polarization mode or a vertical polarization mode. The antenna array is configured to transmit a system beam and receive reflections of the system beam using the horizontal polarization mode, the vertical polarization mode, a right-hand circular polarization mode, or a left-hand circular polarization mode according to the polarization modes of the antenna modules. The system controller and signal processor is configured to set the polarization mode of each antenna module individually, control the antenna array or a first portion thereof to transmit the system beam using a first one of the polarization modes and control the antenna array or a second portion thereof to receive reflections of the system beam using a second one of the polarization modes.

### RELATED APPLICATIONS

This non-provisional patent application claims priority benefit to earlier-filed U.S. Provisional Application No. 63/479,121, entitled “QUAD POLARIZED ELECTRONICALLY STEERED WEATHER RADAR,” filed Jan. 9, 2023, which is herein incorporated by reference into the present application in its entirety.

### BACKGROUND

A weather radar system generally detects the weather that is occurring in front of an aircraft, typically along its flight path. The weather radar system is usually positioned in the forward section of the aircraft and may include an antenna array and a signal processing element. The antenna array may generate a beam to transmit forward of the aircraft. The antenna array may also receive the beam after it has been reflected from clouds or other meteorological formations in front of the aircraft. The antenna array may further have the ability to electronically steer the beam in order to scan portions of the sky. In addition, the antenna array may transmit the beam and receive its reflections using a horizontal polarization or a vertical polarization.

### SUMMARY

Embodiments of the present technology provide an improved weather radar system capable of transmitting a beam and receive its reflections using a horizontal polarization, a vertical polarization, a left-hand circular polarization, or a right-hand circular polarization. Having the additional polarization modes allows the weather radar system to enhance some features of the sky or ground and suppress other features.

Specifically, embodiments of the present technology provide a quad polarimetric electronically steered weather radar system comprising an antenna array and a system controller and signal processor. The antenna array is formed from a plurality of antenna modules, each configured to operate in a horizontal polarization mode or a vertical polarization mode. The antenna array is configured to transmit a system beam and receive reflections of the system beam using the horizontal polarization mode, the vertical polarization mode, a right-hand circular polarization mode, or a left-hand circular polarization mode which varies according to the polarization modes of the antenna modules. The system controller and signal processor is configured to set the polarization mode of each antenna module individually, control the antenna array selectively to transmit the system beam using a first one of the polarization modes and receive reflections of the system beam using a second one of the polarization modes, and control a first portion of the antenna array selectively to transmit the system beam using the first one of the polarization modes and nearly simultaneously control a second portion of the antenna array selectively to receive reflections of the system beam using the second one of the polarization modes.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a schematic block diagram of an electronically steered weather radar system constructed in accordance with various embodiments of the present technology;

FIG. 2 is a block diagram of a mixer component of the electronically steered weather radar system;

FIG. 3 is a block diagram of a switch component of the electronically steered weather radar system;

FIG. 4 is a top view of an antenna array of the electronically steered weather radar system;

FIG. 5 is a view of antenna modules of the antenna array forming a system beam;

FIG. 6 is a side view of an aircraft with the electronically steered weather radar system transmitting the system beam;

FIG. 7 is a top view of the aircraft with the electronically steered weather radar system indicating the azimuth range of the system beam;

FIG. 8 is a side view of the aircraft with the electronically steered weather radar system indicating the elevation range of the system beam;

FIG. 9A is a schematic representation of a cluster of antenna modules operating in a first mode;

FIG. 9B is a schematic representation of the cluster of antenna modules operating in a second mode;

FIG. 9C is a schematic representation of the cluster of antenna modules operating in a third mode;

FIG. 9D is a schematic representation of the cluster of antenna modules operating in a fourth mode;

FIG. 10 is a perspective view of the aircraft with the electronically steered weather radar system performing a first scan for meteorological formations;

FIG. 11 is a perspective view of the aircraft with the electronically steered weather radar system performing a second scan for meteorological formations; and

FIG. 12 is a perspective view of the aircraft with the electronically steered weather radar system performing a third scan for meteorological formations.

The drawing figures do not limit the current invention to the specific embodiments disclosed and described herein. The drawings are not necessarily to scale, emphasis instead being placed upon clearly illustrating the principles of the invention.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Embodiments of the present technology provide a weather radar system for use primarily with aircraft that includes an electronically steerable system beam. The system broadly comprises an antenna array that includes a plurality of antenna modules, each configured to transmit a wireless signal in the radio frequency (RF) range, known as a radar beam or a “beam”, which corresponds to a transmit electronic signal in the RF range. The beams of the antenna modules combine through constructive wave interference to form the system beam. The system controls a waveform characteristic of each electronic signal, such as the phase, frequency, and/or amplitude, in order to (electronically) steer, or control the direction of, the system beam. Once transmitted, the system beam may reflect off cloud formations, rain, snow, ice, or other objects in the sky and/or ground and return to the aircraft. The antenna modules also receive the reflections of the system beam and generate a receive electronic signal which is output from each antenna module. The direction from which the system beam is received is determined by controlling the phase of the receive electronic signals.

The antenna modules are positioned adjacent to one another on a two-dimensional (2D) grid to form the antenna array, which operates in one of four modes, i.e., a horizontal polarization (HP) mode, a vertical polarization (VP) mode, a right-hand circular polarization (RHCP) mode, or a left-hand circular polarization (LHCP) mode, according to, or determined by, the operating modes of the antenna modules or clusters of the antenna modules. Each antenna module operates in either the HP mode or the VP mode. In the HP mode, the antenna module is configured to transmit a module beam and receive reflections of the module beam using HP. In the VP mode, the antenna module is configured to transmit the module beam and receive reflections of the module beam using VP. The system further includes system control and signal processing electronic circuitry which controls the configuration of each antenna module individually to operate in the HP mode or the VP mode. When each antenna module in the antenna array operates in the HP mode, the antenna array operates in the HP mode and the system beam is transmitted and reflections of the system beam are received using HP. When each antenna module operates in the VP mode, the antenna array operates in the VP mode and the system beam is transmitted and reflections of the system beam are received using VP.

When a cluster of antenna modules operate in a mixture of the mode HP and the VP mode, the cluster operates in either the RHCP mode or the LHCP mode according to, or depending on, the operating mode of each individual antenna module in the cluster. In the RHCP mode, the cluster is configured to transmit a cluster beam and receive reflections of the cluster beam using RHCP, wherein the cluster beam is formed by the constructive interference of the module beams. In the LHCP mode, the cluster is configured to transmit the cluster beam and receive reflections of the cluster beam using LHCP. Specifically, the cluster of antenna modules operates in the RHCP mode or the LHCP mode according to the operating mode of the antenna modules along the diagonals of the cluster. For example, a cluster of antenna modules may include four antenna modules positioned in a two by two (2×2) formation. When the two antenna modules along a first diagonal are operating in the HP mode and the two antenna modules along a second diagonal are operating in the VP mode, the cluster is operating in the RHCP mode, meaning the cluster beam is transmitted and reflections of the cluster beam are received using RHCP. A ninety-degree phase difference between HP and VP mode enables the creation of the RHCP/LHCP signal. When the two antenna modules along the first diagonal are operating in the VP mode and the two antenna modules along the second diagonal are operating in the HP mode, the cluster is operating in the LHCP mode, meaning the cluster beam is transmitted and reflections of the cluster beam are received using LHCP. When each of the cluster of antenna modules is operating in the RHCP mode, the antenna array is operating in the RHCP mode, and the system beam is transmitted and reflections of the system beam are received using RHCP. When each of the cluster of antenna modules is operating in the LHCP mode, the antenna array is operating in the LHCP mode, and the system beam is transmitted and reflections of the system beam are received using LHCP. The system control and signal processing electronic circuitry is configured to select the HP mode or the VP mode of each antenna module, and thus can control the antenna array to transmit the system beam and receive reflections of the system beam using HP, VP, RHCP, or LHCP.

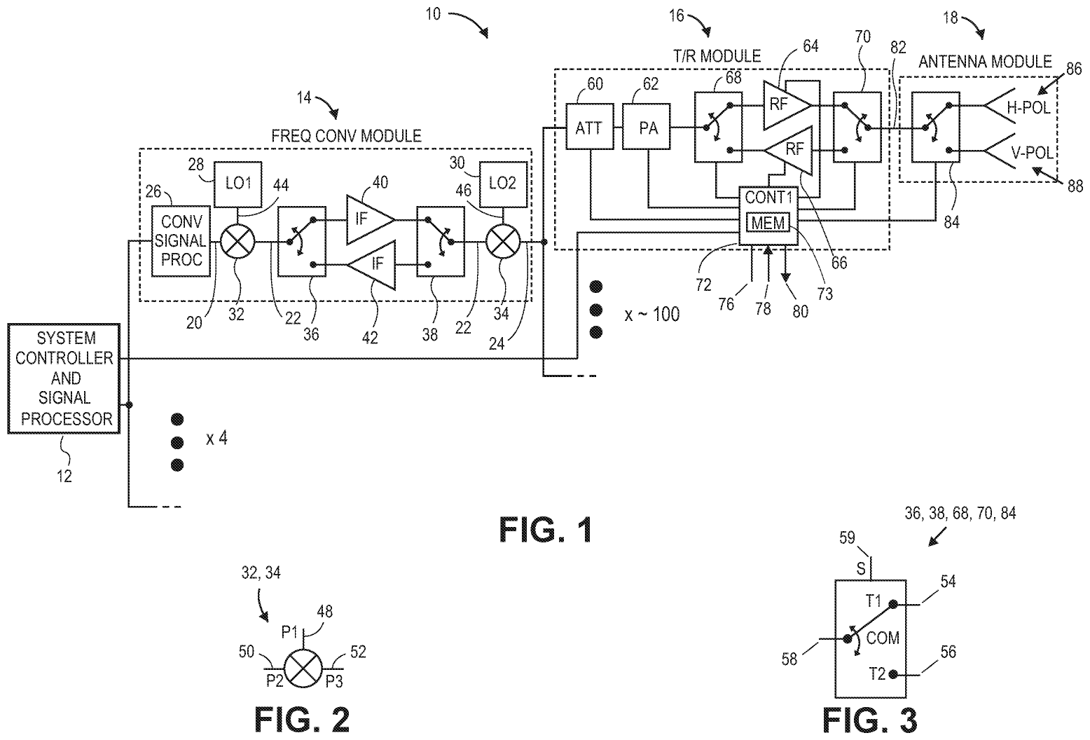

Embodiments of the technology will now be described in more detail with reference to the drawing figures. Referring initially to FIG. 1, an electronically steered weather radar system 10 of the present technology for use with an aircraft is shown and may broadly comprise a system controller and signal processor 12, an array of frequency conversion modules 14, an array of transmit/receive modules 16, and an array of antenna modules 18. The system 10 generally transmits an electronically steered beam and receives the beam after the beam has reflected from clouds or other meteorological formations. Thus, the system 10 may operate in one of several modes including a transmit mode, in which the components, described in more detail below, are configured to transmit the beam from a transmit signal, and a receive mode, in which the components are configured to receive the beam and generate a receive signal.

The terms “azimuth” and “elevation” may be used throughout the specification and may retain their commonly-known definitions, wherein azimuth refers to an orientation in a horizontal plane and may include the directions left and right with respect to the aircraft, and elevation refers to an orientation in a vertical plane and may include the directions up or above and down or below with respect to the aircraft. Generally, zero degrees (0°) in azimuth indicates a vertical plane through the center of the aircraft, as indicated by the 0° line shown in FIG. 7, and negative azimuth is in the direction of the left or port side of the aircraft, while positive azimuth is in the right or starboard direction. Zero degrees elevation indicates a horizontal plane through the center of the aircraft, as indicated by the 0° line shown in FIG. 8. Positive elevation is above the aircraft, while negative elevation is below.

The system controller and signal processor 12 may include processors, microprocessors, digital signal processors (DSPs), microcontrollers, field-programmable gate arrays (FPGAs), application-specific integrated circuits (ASICs), or the like, or combinations thereof. The system controller and signal processor 12 may be operable, configured, and/or programmed to perform the functions, operations, processes, methods, and/or algorithms described herein by utilizing hardware, software, firmware, or combinations thereof. In addition, the system controller and signal processor 12 may be integrated with, or in electronic communication with, a memory element configured to store data in general, and digital or binary data in particular.

The system controller and signal processor 12 may determine whether the system 10 is in the transmit mode or the receive mode. The system controller and signal processor 12 may analyze or sum a baseband signal 20 from each frequency conversion module 14 when the system 10 is in the receive mode, as described in more detail below. The baseband signal 20 may have a baseband frequency, hereinafter “baseband”, level

and may include the range of frequencies from kilohertz (kHz) to hundreds of MHz. The system controller and signal processor 12 may also output signals that are received by the transmit/receive modules 16 to store configuration settings specific to each transmit/receive module 16. In various embodiments, each transmit/receive module 16 also stores configuration settings for the antenna module 18 associated therewith. Each antenna module 18 may operate in a horizontal polarization mode or a vertical polarization mode, as described in more detail below. The system controller and signal processor 12 also determines the operating mode of each antenna module 18 and outputs a control signal or data to set the operating mode of each antenna module 18 individually.

The frequency conversion module 14 generally performs a frequency upconversion when the system 10 is in the transmit mode and a frequency downconversion when the system 10 is in the receive mode. During the upconversion process, the frequency conversion module 14 may convert the frequency of the baseband signal 20 in stages from a baseband level to an intermediate frequency (IF) level and then to a radio frequency (RF) level. After the first upconversion, the baseband signal 20 may become an IF signal 22. The RF level may include the frequency range from gigahertz (GHz) to tens of GHz and may be in the X band region of the microwave range of the electromagnetic spectrum, broadly covering approximately 7 GHz to approximately 12 GHz. In various embodiments, the RF level may include the range of approximately 9.3 GHz to approximately 9.5 GHz. After the second upconversion, the IF signal 22 may become an RF signal 24. During the downconversion process, the frequency conversion module 14 may convert the frequency of the RF signal 24 in stages from the RF level down to the IF level, wherein the RF signal 24 becomes the IF signal 22, and then to the baseband level, wherein the IF signal 22 becomes the baseband signal 20. The baseband signal 20 may be communicated to and from the system controller and signal processor 12. The RF signal 24 may be communicated to and from the transmit/receive modules 16.

In various embodiments, there may be four frequency conversion modules 14 in the system 10. During normal operation, the four frequency conversion modules 14 are all configured in the same manner and perform the same functions and operations. For example, when the system 10 is in the transmit mode all of the frequency conversion modules 14 are configured to perform the upconversion, and when the system 10 is in the receive mode, all of the frequency conversion modules 14 are configured for downconversion.

The frequency conversion module 14 may include a conversion signal processor 26, a first local oscillator 28, a second local oscillator 30, a first mixer 32, a second mixer 34, a first switch 36, a second switch 38, a transmit IF amplifier 40, and a receive IF amplifier 42.

The conversion signal processor 26 may include processors, microprocessors, DSPs, microcontrollers, FPGAs, ASICs, or the like, or combinations thereof. The conversion signal processor 26 may generate the baseband signal 20 that is frequency upconverted and ultimately transmitted by the antenna modules 18. Generally, each conversion signal processor 26 generates the same baseband signal 20, with regard to amplitude, frequency, phase, etc. The conversion signal processor 26 may also sum or at least partially sum the baseband signals 20 that are frequency downconverted from signals received by the antenna modules 18, as described in more detail below.

The first local oscillator 28 may generate an IF level signal. The first local oscillator 28 may include components that are capable of generating an oscillating periodic signal, such as crystal oscillators, oscillator circuits, voltage-controlled oscillator circuits, multivibrator circuits, programmable digital signal processors or digital synthesizers with digital to analog converters, or the like, or combinations thereof. The first local oscillator 28 may generate a first local oscillator signal 44 to be mixed by the first mixer 32.

The second local oscillator 30 may generate an RF level signal. Like the first local oscillator 28, the second local oscillator 30 may include components that are capable of generating an oscillating periodic signal, such as crystal oscillators, oscillator circuits, voltage-controlled oscillator circuits, multivibrator circuits, programmable digital signal processors or digital synthesizers with digital to analog converters, or the like, or combinations thereof. The second local oscillator 30 may generate a second local oscillator signal 46 signal to be mixed by the second mixer 34.

The first mixer 32 generally performs frequency conversion of a signal, either upconversion from a baseband level to an IF level when the system 10 is in the transmit mode, or downconversion from an IF level to a baseband level when in the receive mode. The first mixer 32 may include electronic signal mixing components known in the art, such as active devices including diodes, transistors, or the like, and passive components including resistors or the like, as well as combinations thereof. The first mixer 32, as shown in FIG. 2, may include a first port 48, a second port 50, and a third port 52. The first port 48 may be coupled to the first local oscillator 28, the second port 50 may be coupled to the conversion signal processor 26, and the third port 52 may be coupled to the first switch 36. When the first mixer 32 is upconverting, the conversion signal processor 26 and the first local oscillator 28 may act as inputs and the first switch 36 may receive the output of the first mixer 32, which may have a frequency that is the sum of the frequencies of the baseband signal 20 and the first local oscillator signal 44. When the first mixer 32 is downconverting, the first switch 36 and the first local oscillator 28 may act as inputs and the conversion signal processor 26 may receive the output of the first mixer 32, which may have a frequency that is the difference of the frequencies of the first local oscillator signal 44 and the IF signal 22. In some configurations, the processor 12 may directly sum the received RF signals 24 instead of the baseband signal 20.

The second mixer 34 generally performs frequency conversion of a signal, either upconversion from an IF level to an RF level when the system 10 is in the transmit mode, or downconversion from an RF level to an IF level when in the receive mode. Like the first mixer 32, the second mixer 34 may include electronic signal mixing components known in the art, such as active devices including diodes, transistors, or the like, and passive components including resistors or the like, as well as combinations thereof. Furthermore, the second mixer 34 may have the structure as shown in FIG. 3. The first port 48 of the second mixer 34 may be coupled to the second local oscillator 30, the second port 50 may be coupled to the second switch 38, and the third port 52 may be coupled to the transmit/receive modules 16. When the second mixer 34 is upconverting, the second switch 38 and the second local oscillator 30 may act as inputs and the transmit/receive modules 16 may receive the output of the second mixer 34, which may have a frequency that is the sum of the frequencies of the IF signal 22 and the second local oscillator signal 46. When the second mixer 34 is downconverting, the transmit/receive modules 16 and the second local oscillator 30 may act as inputs and the second switch 38 may receive the output of the second mixer 34, which may have a frequency that is the difference of the frequencies of the second local oscillator signal 46 and the RF signal 24.

The transmit IF amplifier 40 generally amplifies the IF signal 22 when the system 10 is in the transmit mode. The transmit IF amplifier 40 may comprise electronic signal amplifier circuits including active and passive devices, operational amplifiers, single stage or multi stage circuits, or the like, or combinations thereof. An exemplary transmit IF amplifier 40 is a power amplifier. In various embodiments, the transmit IF amplifier 40 may have a fixed gain, although variable gain amplifiers may be used. The transmit IF amplifier 40 may be coupled to the first and second switches 36, 38 such that the transmit IF amplifier 40 amplifies the IF signal 22 when the system 10 is in the transmit mode and is disconnected from the IF signal 22 path when in the receive mode.

The receive IF amplifier 42 generally amplifies the IF signal 22 when the system 10 is in the receive mode. The receive IF amplifier 42 may comprise electronic signal amplifier circuits including active and passive devices, operational amplifiers, single stage or multi stage circuits, or the like, or combinations thereof. An exemplary receive IF amplifier 42 is a small-signal, low-noise amplifier. In various embodiments, the receive IF amplifier 42 may have a fixed gain, although variable gain amplifiers may be used. The receive IF amplifier 42 may be coupled to the first and second switches 36, 38 such that the receive IF amplifier 42 amplifies the IF signal 22 when the system 10 is in the receive mode and is disconnected from the IF signal 22 path when in the transmit mode.

The first switch 36 and the second switch 38 generally select between the transmit IF amplifier 40 and the receive IF amplifier 42. The first switch 36 and the second switch 38 may be substantially similar in structure and function to one another and may include electronic switching components, such as transistors, relays, or the like. The first and second switches 36, 38 may be of single pole, double throw type and each one may include, as shown in FIG. 3, a first terminal 54, a second terminal 56, and a common terminal 58 that contacts either the first terminal 54 or the second terminal 56. The first and second switches 36, 38 may also each include a select line 59 that sets the switch in either a first position, in which contact is made between the first terminal 54 and the common terminal 58, or a second position, in which contact is made between the second terminal 56 and the common terminal 58. The common terminal 58 of the first switch 36 may be coupled to the first mixer 32, the first terminal 54 may be coupled to the input of the transmit IF amplifier 40, and the second terminal 56 may be coupled to the output of the receive IF amplifier 42. The common terminal 58 of the second switch 38 may be coupled to the second mixer 34, the first terminal 54 may be coupled to the output of the transmit IF amplifier, and the second terminal 56 may be coupled to the input of the receive IF amplifier 42. The first and second switches 36, 38 are generally to set to the same position so that when the system 10 is in the transmit mode, the IF signal 22 path from the first mixer 32 to the second mixer 34 is through the transmit IF amplifier 40. And, when the system 10 is in the receive mode, the IF signal 22 path from the second mixer 34 to the first mixer 32 is through the receive IF amplifier 42.

The transmit/receive module 16 generally amplifies and adjusts a phase characteristic of the RF signal 24 in both the transmit mode and the receive mode. When in the transmit mode, the RF signal 24 is to be transmitted by one of the antenna modules 18. When in the receive mode, the RF signal 24 is generated by one of the antenna modules 18. The transmit/receive module 16 may include an attenuator 60, a phase shifter 62, a transmit RF amplifier 64, a receive RF amplifier 66, a third switch 68, a fourth switch 70, and a controller 72. In some embodiments, each frequency conversion module 14 may drive approximately one hundred (100) transmit/receive modules 16. Thus, the system 10 may include approximately four hundred (400) transmit/receive modules 16. In other embodiments, each frequency conversion module 14 may drive approximately sixty-four (64) transmit/receive modules 16. Accordingly, the system 10 may include approximately two hundred fifty-six (256) transmit/receive modules 16.

The attenuator 60 generally attenuates or adjusts the amplitude of the RF signal 24. The attenuator 60 may include variable gain amplifier circuits, operational amplifiers, or the like, or combinations thereof. The attenuator 60 may also include an input to set the gain that is applied to the RF signal 24.

The phase shifter 62 generally adjusts a phase characteristic, such as phase, of the RF signal 24 for each transmit/receive module 16. The phase shifter 62 may include electronic circuitry such as passive and active devices, operational amplifiers, DSPs, or the like, or combinations thereof. The phase shifter 62 may also be programmable or have settings, such as the amount of phase change that the RF signal 24 receives, that can vary and may include an input to select the settings. The phase shifter 62 may adjust the phase of the RF signal 24 any amount, such as for example between 0 degrees, 360 degrees, 720 degrees, and the like. In other embodiments, the phase shifter 62 may include signal delaying components that delay the RF signal 24 by a programmable amount of time. The phase shifter 62 may additionally or alternatively adjust the amplitude and/or frequency of the RF signal 24.

The transmit RF amplifier 64 generally amplifies the RF signal 24 when the system 10 is in the transmit mode. The transmit RF amplifier 64 may comprise electronic signal amplifier circuits including active and passive devices, single stage or multi stage circuits, or the like, or combinations thereof. An exemplary transmit RF amplifier 64 is a power amplifier. In various embodiments, the transmit RF amplifier 64 may have a fixed gain, although variable gain amplifiers may be used. In various embodiments, the transmit RF amplifier 64 may be turned on and off by a control line 74. The transmit RF amplifier 64 may be coupled to the third and fourth switches 68, 70 such that the transmit RF amplifier 64 amplifies the RF signal 24 when the system 10 is in the transmit mode and is disconnected from the RF signal 24 path when in the receive mode.

The receive RF amplifier 66 generally amplifies the RF signal 24 when the system 10 is in the receive mode. The receive RF amplifier 66 may comprise electronic signal amplifier circuits including active and passive devices, single stage or multi stage circuits, or the like, or combinations thereof. An exemplary receive RF amplifier 66 is a small-signal, low-noise amplifier. In various embodiments, the receive RF amplifier 66 may have a fixed gain, although variable gain amplifiers may be used. The receive RF amplifier 66 may be coupled to the third and fourth switches 68, 70 such that the receive RF amplifier 66 amplifies the RF signal 24 when the system 10 is in the receive mode and is disconnected from the RF signal 24 path when in the transmit mode.

The third switch 68 and the fourth switch 70 generally select between the transmit RF amplifier 64 and the receive RF amplifier 66. The third and fourth switches 68, 70 may both have the structure shown in FIG. 3. The common terminal 58 of the third switch 68 may be coupled to the phase shifter 62, the first terminal 54 may be coupled to the input of the transmit RF amplifier 64, and the second terminal 56 may be coupled to the output of the receive RF amplifier 66. The common terminal 58 of the fourth switch 70 may be coupled to the antenna module 18, the first terminal 54 may be coupled to the output of the transmit RF amplifier, and the second terminal 56 may be coupled to the input of the receive RF amplifier 66. The third and fourth switches 68, 70 are generally set to the same position so that when the system 10 is in the transmit mode, the RF signal 24 path from the phase shifter 62 to the antenna module 18 is through the transmit RF amplifier 64. And, when the system 10 is in the receive mode, the RF signal 24 path from the antenna module 18 to the phase shifter 62 is through the receive RF amplifier 66.

The controller 72 generally manages the operation of the transmit/receive module 16. The controller 72 may include components that are capable of executing computer programs, applications, software, code, instructions, algorithms, or firmware, and combinations thereof. The controller 72 may include circuitry, such as finite state machines (FSMs), that automatically performs instructions. The controller 72 may also include processors, microprocessors, microcontrollers, FPGAs, ASICs, combinations thereof, or the like, and may be implemented using hardware description languages (HDLs), such as Verilog and VHDL. An exemplary controller 72 includes an IGLOO nano FPGA manufactured by Microsemi SoC Products Group in Mountain View, Calif. Furthermore, the controller 72 may be electronically coupled to, or in electronic communication with, a data storage component 73 such as read-only memory (ROM), random-access memory (RAM), cache memory, floppy disks, hard-disk drives, optical storage media such as compact discs (CDs or CD-ROMs), digital video disc (DVD), Blu-Ray™, etc., flash memory, combinations thereof, or the like. The IGLOO nano FPGA may include a data storage component 73 such as embedded RAM or FLASH ROM memory storage. The data storage component 73 may also be known as a “computer-readable storage medium” and may be operable to store the computer programs, applications, software, code, instructions, algorithms, or firmware that are executed by the controller 72. The data storage component 73 may also store configuration settings, data, signals that are either transmitted or received, or the like.

The controller 72 may include outputs to change the settings of the attenuator 60, the phase shifter 62, the transmit RF amplifier 64, the receive RF amplifier 66, the third switch 68, and the fourth switch 70.

The controller 72 may further include a boundary scan, or joint test action group (JTAG), capability that follows the IEEE Standard 1149.1. The boundary scan is a serially accessible scan path through the circuitry of the controller 72 that is generally used for testing purposes. Typically, the boundary scan accesses the inputs and outputs of the controller 72 so that both the inputs and the outputs can be controlled and observed. The exemplary IGLOO nano FPGA controller 72 may also include FLASH ROM memory writing capability in the boundary scan. The boundary scan usually requires at least three additional ports on the controller—a first port for a scan clock 76, a second port for a scan input 78, and a third port for a scan output 80. The boundary scanning process may include placing the controller 72 in a scanning mode, shifting data into the scan input 78, and reading data from the scan output 80, wherein one bit of data is shifted in and one bit of data is read out for every period of the scan clock 76. Within the controller 72, the data shifted into the scan input 78 may be stored in the FLASH ROM. The same data may be read out from the scan output 80.

The system 10 may be calibrated to achieve optimal performance for a given physical implementation, such as the positioning of the antenna modules 18, of the system 10. The calibration may include certain parameter settings for the attenuator 60 and the phase shifter 62. These settings may be stored in the data storage components associated with the controller 72, such as the FLASH ROM in the IGLOO nano FPGA.

The transmit/receive modules 16 may also include a scan chain that is formed by the scan output 80 of one controller 72 being connected to the scan input 78 of an adjacent controller 72. In addition, the scan clocks 76 of all the controllers 72 are connected together. The scan chain may receive a data stream that includes parameter settings for the components of the transmit/receive modules 16 to be stored in the FLASH ROM of each controller 72. During a boundary scanning process of the transmit/receive modules 16, the data stream with the parameter settings may be shifted into the scan input 78 of the first controller 72 in the scan chain, and data may be read out from the scan output 80 of the last controller 72 in the scan chain, with the data stream traveling through every controller 72. The order of the FLASH ROM data for each controller 72 in the data stream corresponds to the order of the controllers 72 in the scan chain.

The antenna module 18 may include an antenna signal 82, a fifth switch 84, a horizontally polarized antenna element 86, and a vertically polarized antenna element 88. There is a successive one of the antenna modules 18 coupled to each transmit/receive module 16. In some embodiments, there may be a total of approximately four hundred (400) antenna modules 18 in the system 10. In other embodiments, there may be a total of approximately two hundred fifty-six (256) antenna modules 18 in the system 10.

The antenna signal 82 serves as the main signal to and from the antenna module 18 and may couple with the RF signal 24 from the transmit/receive module 16. The antenna module 18 generally converts the antenna signal 82 into radio waves when transmitting and converts radio waves into the antenna signal 82 when receiving.

The fifth switch 84 generally selects between the horizontally polarized antenna element 86 and the vertically polarized antenna element 88 and has a structure as shown in FIG. 3. The common terminal 58 may be coupled to the transmit/receive module 16, the first terminal 54 may be coupled to the horizontally polarized antenna element 86, and the second terminal 56 may be coupled to the vertically polarized antenna element 88. The fifth switch 84 may couple the antenna signal 82 to the horizontally polarized antenna element 86 when the fifth switch 84 is in the first position and may couple the antenna signal 82 to the vertically polarized antenna element 88 when the fifth switch 84 is in the second position.

The selection setting of the fifth switch 84 is received from the controller 72, which in turn may receive the selection setting from the system controller and signal processor 12. The system controller and signal processor 12 is configured to control the selection setting of the fifth switch 84, i.e., the horizontally polarized antenna element 86 or the vertically polarized antenna element 88, of each antenna module 18 individually.

The antenna module 18 may operate in one of two modes including a horizontal polarization (HP) mode and a vertical polarization (VP) mode. When the horizontally polarized antenna element 86 is selected, the antenna module 18 operates in the HP mode. When the vertically polarized antenna element 88 is selected, the antenna module 18 operates in the VP mode.

The horizontally polarized antenna element 86 may include radiating elements that are designed to operate in the X band frequency range. Various embodiments of the horizontally polarized antenna element 86 may include a patch antenna oriented or configured to transmit and receive radio waves with a horizontal polarization.

The vertically polarized antenna element 88 may also include radiating elements that are designed to operate in the X band frequency range. Various embodiments of the vertically polarized antenna element 88 may include a patch antenna oriented or configured to transmit and receive radio waves with a vertical polarization. In some embodiments, the vertically polarized antenna element 88 may be combined with the horizontally polarized antenna element 86.

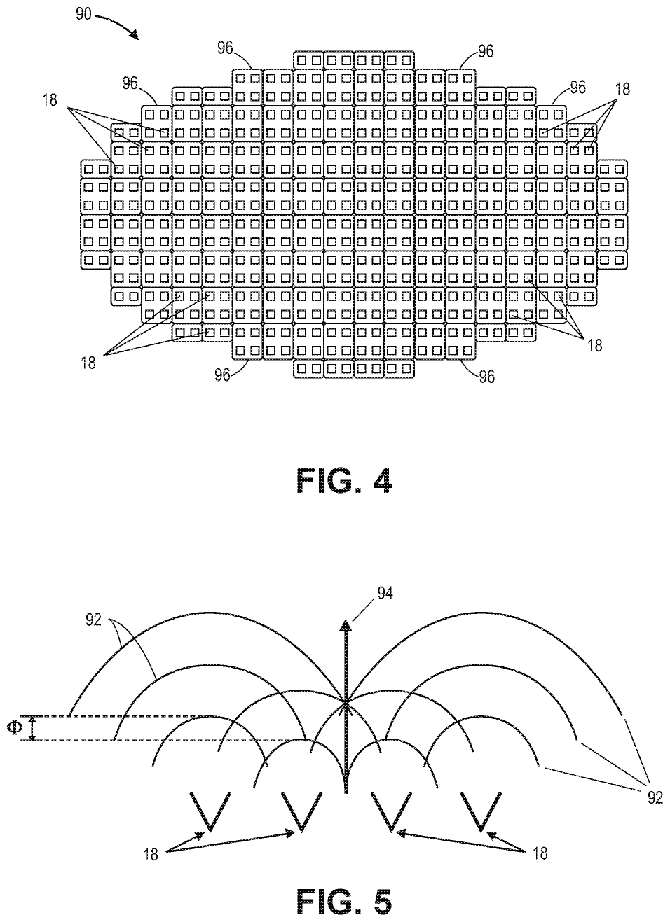

The plurality of antenna modules 18 may be integrated in a single structure to form an antenna array 90. An exemplary implementation of the antenna array 90 is shown in FIG. 4 wherein the antenna modules 18 may be distributed in a two-dimensional (2D) array of rows and columns on one or more substrates, such as a printed circuit board, ceramic base, or other material. Each antenna module 18 may be embedded or otherwise attached to the substrate. In the embodiment of FIG. 4, the rows of antenna modules 18 in the array 90 may be arranged in parallel. However, the antenna modules 18 may be positioned in any configuration on the substrate. The antenna array 90 may be installed in a forward-pointing portion of an aircraft, typically on the exterior of the nose of the aircraft.

Each antenna module 18 in the antenna array 90 may transmit and receive an individual module beam 92. However, the plurality of transmit/receive modules 16 and antenna modules 18 may function as a single transmitting and receiving unit if each transmit/receive module 16 is properly configured by the system controller and signal processor 12. When the system 10 is transmitting, the transmit IF amplifier 40 and the transmit RF amplifier 64 are powered, and the receive IF amplifier 42 and the receive RF amplifier 66 are not powered. The module beam 92 for at least a first antenna module 18 may be generated at an arbitrary time referred to as time zero. The module beams 92 for at least a portion of the other antenna modules 18 may be generated out of phase with respect to the module beam 92 from the first antenna module 18. The phase and/or other phase characteristic of each module beam 92 may be set by phase shifter 62 of each transmit/receive module 16, which adjusts the phase and/or other phase characteristic of the RF signal 24 that, in turn, is radiated by the antenna module 18. The wave-like nature of the transmitted module beams 92 from all of the antenna modules 18 creates constructive and destructive interference patterns in space, such that in at least one direction constructive interference creates a system beam 94, while in other directions destructive interference cancels, or at least strongly attenuates, the other module beams 92.

This phenomenon is illustrated in FIG. 5, which shows four antenna modules 18 from the antenna array 90, with each antenna module 18 generating a module beam 92. The wavefronts of each module beam 92 are shown as arcuate lines. The difference between the wavefronts of adjacent module beams 92 is the phase, shown as Φ, between the module beams 92, which is set by the phase shifter 62 of each transmit/receive module 16. In the illustrated example, the constructive interference of the module beams 92 creates the system beam 94 in a direction that is at an angle of approximately 90 degrees with respect to the antenna modules 18.

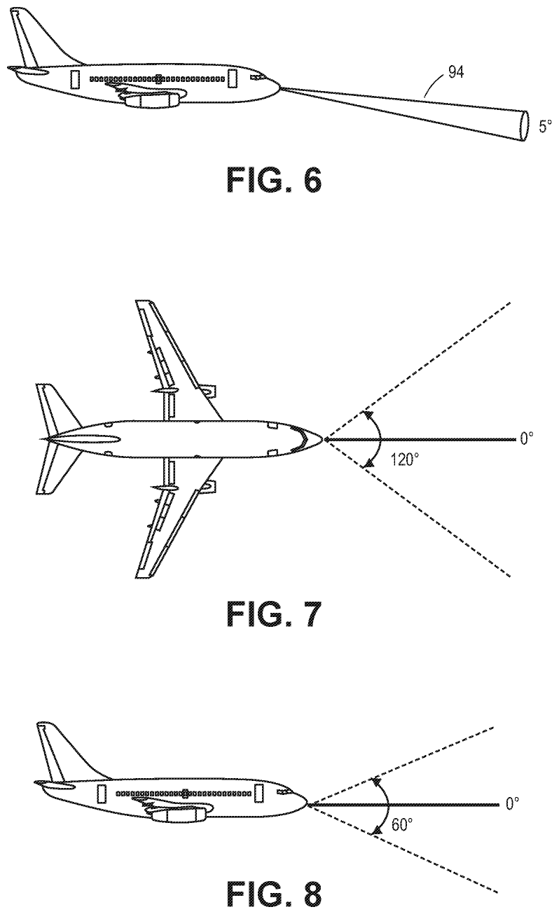

Although the radio wave output of the system 10 is shown in FIG. 5 as a single system beam 94, in reality there may be sidelobes to the system beam 94 that are produced as well. But the system beam 94 as shown includes most of the power that is produced by the antenna array 90, and thus a single system beam 94 will be discussed hereinafter. Furthermore, the system beam 94 may be considered to have a conical shape, as shown in FIG. 6. The angle of the cone may be referred to as the beamwidth. In various embodiments, the beamwidth may be approximately 5 degrees. In addition, the adjustment of the system beam 94 generally sets the direction of the center of the beam.

The direction of the system beam 94 may be changed by changing the phase between the module beams 92. By properly setting the phase and/or other phase characteristic in the phase shifter 62 of each transmit/receive module 16, the direction of the system beam 94 may be adjusted both in azimuth and elevation. The range of azimuth angles in which the system beam 94 is directed, as shown in FIG. 7, may be approximately 120 degrees or approximately −60 degrees to approximately +60 degrees, although other ranges are possible. The range of elevation angles in which the system beam 94 is directed, as shown in FIG. 8, may be approximately 60 degrees or approximately −30 degrees to approximately +30 degrees, although other ranges are possible. Furthermore, the direction of the system beam 94 may be changed by large values in both azimuth and elevation without having to be set to intervening values. For example, the system beam 94 may be adjusted to 30 degrees azimuth, 20 degrees elevation in a first setting. The system beam 94 may then be adjusted −10 degrees azimuth, −15 degrees elevation in a second setting without adjusting to any values there between.

The system beam 94 may be transmitted from the antenna array 90 into the space in front of the aircraft and may reflect off of clouds or other meteorological formations, as well as other aircraft and ground formations such as trees, buildings, hills, mountains, or the like. Typically, the system beam 94 reflects off of objects and is received by the antenna array 90 in the same direction at which it was transmitted from the antenna array 90.

When the system 10 is receiving, similar phase shifting techniques may be utilized to determine the direction at which electromagnetic radiation is received. The phase and/or other phase characteristic of the phase shifter 62 for each transmit/receive module 16 may be set as discussed above for a given direction of the system beam 94. However, in the receive mode, the transmit IF amplifier 40 and the transmit RF amplifier 64 are not powered, and the system beam 94 is not transmitted. Instead, the receive IF amplifier 42 and the receive RF amplifier 66 are powered and all the 36, 38, 68, 70, 84 are set such that electromagnetic radiation received by the antenna module 18 is coupled to the antenna signal 82 which in turn is frequency downconverted from the RF signal 24 to the baseband signal 20. The phase of the phase shifter 62 for each transmit/receive module 16 may be adjusted and the baseband signals 20 from the frequency conversion modules 14 are summed together by the system controller and signal processor 12. The sum of the signals may determine the power of the electromagnetic radiation that is present in the direction determined by the phase setting of the phase shifter 62 of all of the transmit/receive modules 16. Generally, the direction of receiving electromagnetic radiation is the same direction as the system beam 94 was transmitted. If the system beam 94 reflected off of an object, then the electromagnetic radiation received likely includes at least some portion of the system beam 94. The power level of the received system beam 94 may depend on a number of factors, such as the distance of the object, the shape of the object, physical characteristics of the object, such as density, radar cross section (RCS), etc.

As with transmitting the system beam 94, when the system 10 is receiving the system beam 94 the direction of the system beam 94 may be changed abruptly from a first setting to a second setting without adjusting the direction to values therebetween. In addition, the system 10 may be configured to transmit the system beam 94 in a first direction and receive the system beam 94 in a second, different direction.

In addition to controlling the phase of the transmit and receive electronic signals, which in turn controls the direction in which the system beam 94 is transmitted and reflections of the system beam 94 are received, the polarization of the system beam 94 may also be controlled. As discussed above, the system controller and signal processor 12 sets the operating mode of each antenna module 18 to HP or VP. When each antenna module 18 is operating in the HP mode, each module beam 92 is transmitted and reflections of each module beam 92 are received using HP, and in turn, the system beam 94 is transmitted and reflections of the system beam 94 are received using HP. In addition, the antenna array is operating in the HP mode. When each antenna module 18 is operating in the VP mode, each module beam 92 is transmitted and reflections of each module beam 92 are received using VP, and in turn, the system beam 94 is transmitted and reflections of the system beam 94 are received using VP. In addition, the antenna array is operating in the VP mode.

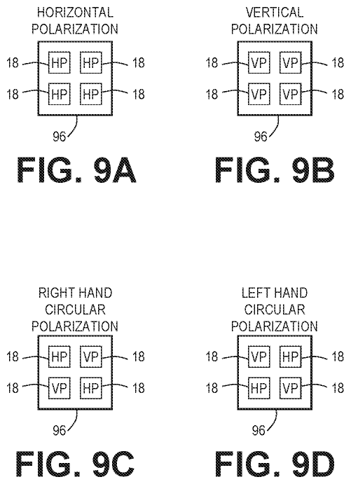

When the operating/polarization mode of a cluster 96 of antenna modules 18 adjacent to one another is varied among the antenna modules 18, the cluster 96 operates in a right-hand circular polarization (RHCP) mode or a left-hand circular polarization (LHCP) mode. In the RHCP mode, the cluster 96 transmits a cluster beam and receives reflections of the cluster beam using RHCP, wherein the cluster beam is formed from the constructive interference combination of the module beams 92. In the LHCP mode, the cluster 96 transmits the cluster beam and receives reflections of the cluster beam using LHCP. The antenna array 90 may include a plurality of clusters 96, with each cluster 96 being formed by a group of antenna modules 18 adjacent to one another in a square shape, that is, the same number of antenna modules 18 in a row as are in a column. Referring to FIGS. 4 and 9A-9D, an exemplary cluster 16 includes four (4) antenna modules 16 in a two by two (2×2) configuration. Other geometric configurations are possible. For instance, in some examples, cluster 16 may be arranged in a triangular lattice configuration, where one column or one row of the cluster 16 are shifted by half an element spacing (pitch). Additional configurations may be generated by shifting the modules 18, rows of modules 18, and/or columns of modules 18 by any desired amount.

Reiterating the discussion of HP and VP modes from above, when each of the antenna modules 18 in one cluster 96 is operating in the HP mode, as shown in FIG. 9A, the cluster 96 operates in the HP mode. When each of the antenna modules 18 in one cluster 96 is operating in the VP mode, as shown in FIG. 9B, the cluster 96 operates in the VP mode. However, when the operating mode of one of the diagonals of the cluster 96 varies from the operating mode of the other diagonal, then the cluster 96 operates in either the RHCP mode or the LHCP mode according to the order of the operating mode of the diagonals. When each of the antenna modules 18 along a first diagonal of the cluster 96 is operating in the HP mode and each of the antenna modules 18 along a second diagonal is operating in the VP mode, as shown in FIG. 9C, the cluster 96 operates in the RHCP mode. When each of the antenna modules 18 along the first diagonal of the cluster 96 is operating in the VP mode and each of the antenna modules 18 along the second diagonal is operating in the HP mode, as shown in FIG. 9D, the cluster 96 operates in the LHCP mode. Furthermore, when each of the clusters 96 is operating in the RHCP mode, the antenna array 90 is operating in the RHCP mode and the system beam 94 is transmitted and reflections of the system beam are received using RHCP. When each of the clusters 96 is operating in the LHCP mode, the antenna array 90 is operating in the LHCP mode and the system beam 94 is transmitted and reflections of the system beam are received using LHCP. In order for the 2×2 antenna module to generate RHCP/LHCP, a ninety degree phase shift must be applied to the diagonals of the module.

The system 10 may operate as follows. The system 10 may perform a general scan of the space in front of the aircraft on a periodic basis, where the period may be on the order of tens of seconds. The general scan may include setting the elevation angle of the system beam 94 to a value at either the upper end or the lower end of its range and setting the azimuth angle to a value either at the left end or the right end of its range. The antenna array 90 may transmit a pulse of the system beam 94 and detect if the system beam 94 is reflected. The azimuth angle may be stepped (either incremented or decremented) by a first azimuth step value followed by the antenna array 90 transmitting a pulse of the system beam 94 and detecting any reflected module beams 92. The system controller and signal processor 12 may change the azimuth angle of the system beam 94 by adjusting the phase of the phase shifter 62 of each transmit/receive module 16, as described above. The azimuth angle may be stepped until it reaches the end of its range, wherein at each step, a pulse is transmitted and reflected module beams 92 are detected. Subsequently, the elevation angle may be stepped by a first elevation step value. The system controller and signal processor 12 may also change the elevation angle by adjusting the phase of the phase shifter 62 of each transmit/receive module 16, as described above. The azimuth angle may be set to either the left end or the right end of its range. The process of stepping the azimuth angle through its range and transmitting pulses and detecting module beams 92 at each step may be repeated in a raster fashion for each value of the elevation angle until the elevation angle reaches the end of its range. Other methods of rastering the system beam 94 to perform the general scan are also possible.

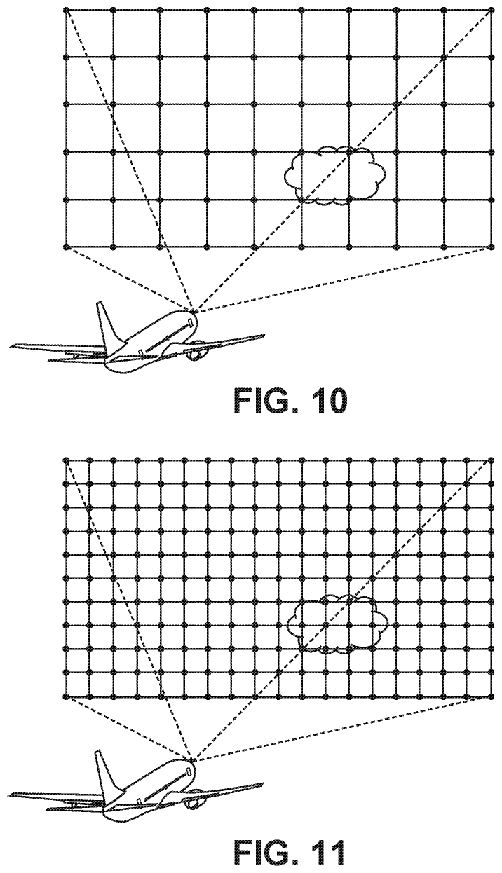

While scanning, the system 10 may generate the system beam 94 on a grid, such as the one shown in FIG. 10, wherein the upper, lower, left, and right limits of the grid are determined by the range of azimuth and elevation scan angles. The grid points represent the points in space where the system beam 94 is transmitted and received signals are processed. The distance between the grid points represents the azimuth step value and the elevation step value. During a general scan, the grid spacing may be coarse, wherein the azimuth step value and the elevation step value may be integer multiples of the beamwidth, such that there is no overlapping of the system beam 94 during the general scan. In addition, during any scan, the azimuth step value may be different from the elevation step value.

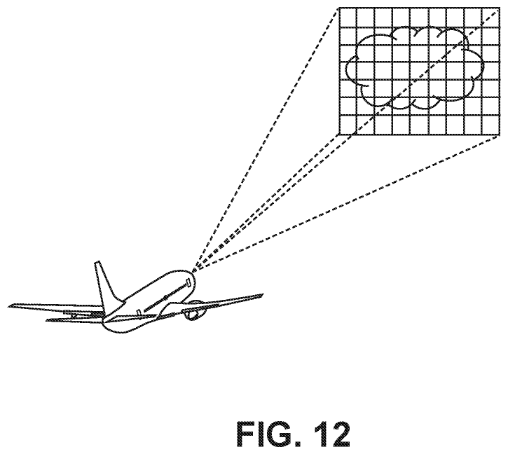

If the power level of the received signals is above a certain threshold, then a higher resolution scan may be performed, as shown in FIG. 11. The higher resolution scan may also be performed on a periodic basis. During the higher resolution scan, the system 10 may perform the same steps as discussed above for the general scan, except that the azimuth step value and the elevation step value may be equal to or less than the beamwidth. In this fashion, the system beam 94 may overlap itself at each point of the scan.

The system 10 may also perform a selective scan in response to the power level of the received signals being above a certain threshold. The corners of the scan may be just outside of the extents of the area in which higher power levels of the received signals were detected, as shown in FIG. 12. The system 10 may also scan the area at a higher resolution, such that the azimuth step value and the elevation step value may be equal to or less than the beamwidth.

When performing a scan, the system 10 may also determine the range of the scan, wherein the range is the maximum distance away from the aircraft at which the system 10 can detect the reflected system beam 94. The range is determined by the amount of time the system 10 spends in the receive mode after the system beam 94 has been transmitted. Typically, the antenna array 90 transmits the system beam 94 as one or more pulses. Then, the system 10 switches to the receive mode in which the baseband signals 20 are summed by the system controller and signal processor 12 in a repeated fashion. The system 10 may continue to sum the baseband signals 20 for a first period of time equal to the time that it takes the system beam 94 to travel the range distance, for example, 100 nautical miles, reflect off of an object, and return to the system 10 to be received by the antenna array 90. Thus, the system 10 may detect clouds and other meteorological formations at the range distance and less, but not beyond the range distance. After the first period of time has passed, the system 10 may reconfigure the phase shifter 62 of each transmit/receive module 16 to change the direction of the system beam 94 and then transmit the system beam 94. After transmitting the system beam 94, the system 10 switches to the receive mode and the process repeats for each grid point of the scan. The range of the scan, among other factors, may also determine the amount of time it takes to perform a scan. The greater the range distance, the greater the period of time the system 10 has to remain in receive mode for each grid point of the scan. Likewise, the shorter the range distance, the shorter the period of time the system 10 has to remain in receive mode for each grid point of the scan.

By controlling the range distance of the scan, the system 10 may perform a three-dimensional volumetric scan of at least a portion of the space in front of the aircraft. The system 10 may perform a first scan as shown in FIG. 10, 11, or 12 at a first range. The system 10 may increase (or decrease) the range by a range step value and may perform a second scan at the second range distance. The process may continue until the desired number of scans at the desired ranges have been performed.

The system 10 may perform scans while changing the polarization of the system beam 94, as set by the system controller and signal processor 12. Each antenna module 18 includes the horizontally polarized antenna element 86 for transmitting and receiving horizontally polarized module beams 92 and the vertically polarized antenna element 88 for transmitting and receiving vertically polarized module beams 92. If all of the antenna modules 18 in the antenna array 90 have the same polarization of antenna selected, then the system beam 94 may have either a horizontal polarization or a vertical polarization. Meteorological formations as well as ground objects reflect horizontally polarized and vertically polarized module beams 92 differently. For example, raindrops, also known as hydrometeors, may flatten and become wider as they are falling through the sky. Consequently, raindrops may reflect more energy from a horizontally-polarized module beam 92 than a vertically-polarized module beam 92. The system 10 may transmit and receive a horizontally polarized system beam 94 followed by transmitting and receiving a vertically polarized system beam 94, or vice-versa. The received system beams 94 from the two different polarizations may be compared so that differences between the two can be determined.

In addition, the system 10 performs system beam 94 transmission using other polarization sequences. The system controller and signal processor 12 controls the antenna array 90 by configuring each frequency conversion module 14, each transmit/receive module 16, and each antenna module 18 to transmit the system beam 94 using a first one of the polarization modes and to receive reflections of the system beam 94 using a second one of the polarization modes. For example, the system controller and signal processor 12 may control the antenna array 90 to transmit the system beam 94 using the HP mode and to receive reflections of the system beam 94 using the VP mode, or vice versa. Or, the system controller and signal processor 12 may control the antenna array 90 to transmit the system beam 94 using the LHCP mode and to receive reflections of the system beam 94 using the RHCP mode, or vice versa. During these sequences, the system controller and signal processor 12 may control the antenna array 90 to operate in a pulsed mode, wherein the system controller and signal processor 12 controls the antenna array 90 to transmit the system beam 94 as one or more pulses rather than a continuous wave. When the antenna array 90 transmits the system beam 94 as a pulse and receives reflections of the system 94 as a pulse, it is operating in a “pulsed pair” mode.

Furthermore, the system controller and signal processor 12 controls the antenna array 90 to transmit the system beam 94 using a first portion of the antenna array 90 in a first one of the polarization modes and nearly simultaneously to receive reflections of the system beam 94 using a second portion of the antenna array 90 in a second one of the polarization modes. Typically, the first portion and the second portion are each percentages that add together to equal 100%, although total percentages less than 100% are possible. For example, the system controller and signal processor 12 may control a first half of the antenna array 90 to transmit the system beam 94 using the HP mode, while controlling a second half of the antenna array 90 nearly simultaneously to receive reflections of the system beam 94 using the VP mode, or vice versa. Or, the system controller and signal processor 12 may control the first half of the antenna array 90 to transmit the system beam 94 using the LHCP mode, while controlling the second half of the antenna array 90 nearly simultaneously to receive reflections of the system beam 94 using the RHCP mode, or vice versa.

The usage of a first polarization mode for transmitting the system beam 94 and a second, different polarization mode for receiving reflections of the system beam 94 provides suppression of some features of a target scene and enhancement of other features for various situations. For example, when trying to detect weather conditions, it may be advantageous to enhance rain and snow while suppressing ground returns. On the other hand, when trying to detect a runway, it may be advantageous to enhance ground features while suppressing precipitation or cloud formations. The system controller and signal processor 12 may be further configured to execute pre-defined programs for weather condition scouting, runway detection, and the like, wherein the polarization mode is varied appropriately between transmitting the system beam 94 and receiving system beam 94 reflections, as described above, to perform the desired task.

The system 10 may perform a self test to verify the operation of the frequency conversion modules 14, the transmit/receive modules 16, and the antenna modules 18. The system 10 includes four frequency conversion modules 14. In some embodiments, each frequency conversion module 14 is coupled to approximately one hundred (100) transmit/receive modules 16, wherein each transmit/receive module 16 is coupled to an antenna module 18. In other embodiments, each frequency conversion module 14 is coupled to approximately sixty-four (64) transmit/receive modules 16. The self test may be utilized with other partitioning schemes of the system 10 as well. A first portion of the frequency conversion modules 14 and the associated transmit/receive modules 16 may be configured to be in the transmit mode, while a second portion of the frequency conversion modules 14 and the associated transmit/receive modules 16 may be configured to be in the receive mode. For example, one frequency conversion module-transmit/receive module 16 combination could be in one mode while the other three frequency conversion module-transmit/receive module 16 combinations are in the other mode. Alternatively, two frequency conversion module-transmit/receive module 16 combinations could be in the transmit mode while the other two frequency conversion module-transmit/receive module 16 combinations are in the receive mode. The first portion may transmit one or more module beams 92 that are received by the second portion while the module beams 92 are being transmitted. Since the module beams 92 that are received should be similar to the module beams 92 that were transmitted, the system 10 may determine which frequency conversion modules 14, transmit/receive modules 16, or combinations thereof are not functioning properly.

The system 10 may effectively reduce the width of the system beam 94 by processing the baseband signals 20 that are generated when the system 10 is in receive mode. The system 10 may perform a scan as shown in FIG. 10, 11, or 12. The system controller and signal processor 12 or one or more conversion signal processors 26 may perform a two-dimensional fast Fourier transform (2D FFT) on the received data. The transformed data may be multiplied by the 2D FFT of a filter function that represents an inverse of an impulse response of the antenna array 90. The product may then undergo an inverse 2D FFT to return the data to the time domain. This process may reduce the distortion or other anomalies in the received data as a result of the antenna array 90, thereby having the effect of reducing the width of the system beam 94 or enhancing its resolution.

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A quad polarimetric electronically steered weather radar system comprising:
an antenna array formed from a plurality of antenna modules, each antenna module configured to operate selectively in a horizontal polarization mode or a vertical polarization mode, the antenna array configured to transmit a system beam and receive reflections of the system beam using the horizontal polarization mode, the vertical polarization mode, a right-hand circular polarization mode, or a left-hand circular polarization mode which varies according to the polarization modes of the antenna modules; and
a system controller and signal processor configured to
set the polarization mode of each antenna module individually,
control the antenna array selectively to transmit the system beam using a first one of the polarization modes and receive reflections of the system beam using a second one of the polarization modes, and
control a first portion of the antenna array selectively to transmit the system beam using the first one of the polarization modes and nearly simultaneously control a second portion of the antenna array selectively to receive reflections of the system beam using the second one of the polarization modes.

2. The quad polarimetric electronically steered weather radar system of claim 1, wherein the antenna array further includes a plurality of antenna module clusters, each antenna module cluster formed from a portion of the antenna modules and configured to operate in the horizontal polarization mode, the vertical polarization mode, a right-hand circular polarization mode, or a left-hand circular polarization mode according to the polarization mode of the antenna modules that form the antenna module cluster.

3. The quad polarimetric electronically steered weather radar system of claim 2, wherein the antenna array is configured to transmit the system beam and receive reflections of the system beam using the right-hand circular polarization mode when each antenna module cluster is operating the right-hand circular polarization mode.

4. The quad polarimetric electronically steered weather radar system of claim 2, wherein the antenna array is configured to transmit the system beam and receive reflections of the system beam using the left-hand circular polarization mode when each antenna module cluster is operating in the left-hand circular polarization mode.

5. The quad polarimetric electronically steered weather radar system of claim 2, wherein each antenna module cluster includes four antenna modules positioned in a two by two formation.

6. The quad polarimetric electronically steered weather radar system of claim 5, wherein each antenna module cluster is configured to operate in the right-hand circular polarization mode when the antenna modules of a first diagonal of the antenna module cluster are operating in the horizontal polarization mode and the antenna modules of a second diagonal of the antenna module cluster are operating in the vertical polarization mode.

7. The quad polarimetric electronically steered weather radar system of claim 5, wherein each antenna module cluster is configured to operate in the left-hand circular polarization mode when the antenna modules of a first diagonal of the antenna module cluster are operating in the vertical polarization mode and the antenna modules of a second diagonal of the antenna module cluster are operating in the horizontal polarization mode.

8. The quad polarimetric electronically steered weather radar system of claim 1, wherein the antenna array is configured to transmit the system beam and receive reflections of the system beam using the horizontal polarization mode when each antenna module is operating in the horizontal polarization mode.

9. The quad polarimetric electronically steered weather radar system of claim 1, wherein the antenna array is configured to transmit the system beam and receive reflections of the system beam using the vertical polarization mode when each antenna module is operating in the vertical polarization mode.

10. The quad polarimetric electronically steered weather radar system of claim 1, wherein
each antenna module transmits a module beam and receives reflections of the module beam using a horizontal polarization when the antenna module is operating in the horizontal polarization mode; and
each antenna module transmits the module beam and receives reflections of the module beam using a vertical polarization when the antenna module is operating in the vertical polarization mode.

11. The quad polarimetric electronically steered weather radar system of claim 1, wherein each antenna module includes a first antenna element configured to transmit a module beam and receive reflections of the module beam using a horizontal polarization and a second antenna element configured to transmit the module beam and receive reflections of the module beam using a vertical polarization.

12. The quad polarimetric electronically steered weather radar system of claim 1, wherein the antenna modules are positioned adjacent to one another to form a two-dimensional grid.

13. A quad polarimetric electronically steered weather radar system comprising:
an antenna array including
a plurality of antenna modules, each antenna module configured to operate selectively in a horizontal polarization mode or a vertical polarization mode,
a plurality of antenna module clusters, each antenna module cluster formed from a portion of the antenna modules and configured to operate in the horizontal polarization mode, the vertical polarization mode, a right-hand circular polarization mode, or a left-hand circular polarization mode according to the polarization mode of the antenna modules that form the antenna module cluster,
the antenna array configured to transmit a system beam and receive reflections of the system beam using the horizontal polarization mode, the vertical polarization mode, the right-hand circular polarization mode, or the left-hand circular polarization mode which varies according to the polarization modes of the antenna module clusters; and
a system controller and signal processor configured to
set the polarization mode of each antenna module individually,
control the antenna array selectively to transmit the system beam using a first one of the polarization modes and receive reflections of the system beam using a second one of the polarization modes, and
control a first portion of the antenna array selectively to transmit the system beam using the first one of the polarization modes and nearly simultaneously control a second portion of the antenna array selectively to receive reflections of the system beam using the second one of the polarization modes.

14. The quad polarimetric electronically steered weather radar system of claim 13, wherein
the antenna array is configured to transmit the system beam and receive reflections of the system beam using the right-hand circular polarization mode when each antenna module cluster is operating the right-hand circular polarization mode, and
the antenna array is configured to transmit the system beam and receive reflections of the system beam using the left-hand circular polarization mode when each antenna module cluster is operating in the left-hand circular polarization mode.

15. The quad polarimetric electronically steered weather radar system of claim 13, wherein each antenna module cluster includes four antenna modules positioned in a two by two formation.

16. The quad polarimetric electronically steered weather radar system of claim 15, wherein
each antenna module cluster is configured to operate in the right-hand circular polarization mode when the antenna modules of a first diagonal of the antenna module cluster are operating in the horizontal polarization mode and the antenna modules of a second diagonal of the antenna module cluster are operating in the vertical polarization mode, and
each antenna module cluster is configured to operate in the left-hand circular polarization mode when the antenna modules of the first diagonal of the antenna module cluster are operating in the vertical polarization mode and the antenna modules of the second diagonal of the antenna module cluster are operating in the horizontal polarization mode.

17. The quad polarimetric electronically steered weather radar system of claim 13, wherein
the antenna array is configured to transmit the system beam and receive reflections of the system beam using the horizontal polarization mode when each antenna module is operating in the horizontal polarization mode, and
the antenna array is configured to transmit the system beam and receive reflections of the system beam using the vertical polarization mode when each antenna module is operating in the vertical polarization mode.

18. The quad polarimetric electronically steered weather radar system of claim 1, wherein each antenna module includes
a first antenna element configured to transmit a module beam and receive reflections of the module beam using a horizontal polarization when the antenna module is operating in the horizontal polarization mode, and
a second antenna element configured to transmit the module beam and receive reflections of the module beam using a vertical polarization when the antenna module is operating in the vertical polarization mode.

19. The quad polarimetric electronically steered weather radar system of claim 1, wherein the antenna modules are positioned adjacent to one another to form a two-dimensional grid.

20. A quad polarimetric electronically steered weather radar system comprising:
an antenna array including
a plurality of antenna modules positioned adjacent to one another to form a two-dimensional grid, each antenna module configured to operate selectively in a horizontal polarization mode or a vertical polarization mode,
a plurality of antenna module clusters, each antenna module cluster including four antenna modules positioned in a two by two formation and configured to operate in
the horizontal polarization mode when each antenna module of the antenna module cluster is operating in the horizontal polarization mode,
the vertical polarization mode when each antenna module of the antenna module cluster is operating in the vertical polarization mode,
a right-hand circular polarization mode when the antenna modules of a first diagonal of the antenna module cluster are operating in the horizontal polarization mode and the antenna modules of a second diagonal of the antenna module cluster are operating in the vertical polarization mode, or
a left-hand circular polarization mode when the antenna modules of the first diagonal of the antenna module cluster are operating in the vertical polarization mode and the antenna modules of the second diagonal of the antenna module cluster are operating in the horizontal polarization mode,
the antenna array configured to transmit a system beam and receive reflections of the system beam using the horizontal polarization mode, the vertical polarization mode, the right-hand circular polarization mode, or the left-hand circular polarization mode which varies according to the polarization modes of the antenna module clusters; and
a system controller and signal processor configured to
set the polarization mode of each antenna module individually,
control the antenna array selectively to transmit the system beam using a first one of the polarization modes and receive reflections of the system beam using a second one of the polarization modes, and
control a first portion of the antenna array selectively to transmit the system beam using the first one of the polarization modes and nearly simultaneously control a second portion of the antenna array selectively to receive reflections of the system beam using the second one of the polarization modes.
